(19) United States
(12) Patent Application Publication
(10) Pub. No.: US 2015/0281157 A1
(43) Pub. Date: Oct. 1, 2015

(54) Delivering an Action

(71) Applicant: Microsoft Corporation, Redmond, WA (US)

(72) Inventors: Steve James Pearce, London (GB); Mark Robert Swift, Surrey (GB); Soramist Chintanamanus, London (GB)

(21) Appl. No.: 14/444,506

(22) Filed: Jul. 28, 2014

(30) Foreign Application Priority Data
Mar. 28, 2014 (GB) 1405651.9

(51) Int. Cl. H04L 12/58

(52) U.S. Cl. CPC H04L 51/18

(57) ABSTRACT

A method implemented during a communication event between a plurality of user devices over a communication network, the method comprising: identifying a first co-operating element in a first message transmitted from one of said user devices; identifying a second co-operating element in a second message transmitted from one of said user devices; querying a memory to identify an action associated with the combination of the first and at least the second co-operating element; and transmitting a message to each of the plurality of user devices to cause delivery of the action using output means at the plurality of user devices.

### RELATED APPLICATIONS

This application claims priority under 35 USC §119 or §365 to Great Britain Patent Application No. 1405651.9 entitled “DELIVERING AN ACTION” filed Mar. 28, 2014, the disclosure of which is incorporate in its entirety.

### BACKGROUND

Packet-based communication systems allow the user of a device, such as a personal computer, to communicate across the computer network using a packet protocol such as Internet Protocol (IP). Packet-based communication systems can be used for various types of communication events. Communication events which can be established include voice calls, video calls, instant messaging, voice mail, file transfer and others. These systems are beneficial to the user as they are often of significantly lower cost than fixed line or mobile networks. This may particularly be the case for long-distance communication. To use a packet-based system, the user installs and executes client software on their device. The client software provides the packet-based connections as well as other functions such as registration and authentication.

Communications systems allow users of devices to communicate across a computer network such as the internet. Communication events which can be established include voice calls, video calls, instant messages, voice mail, file transfers and others.

An instant messaging communication session allows a chat to be conducted between users of computer devices via a computer network. Each user can enter text into a field, actuate a send button and thereby create an instant message which is communicated to another user. It is known to allow the inclusion of icons that represent emotions or expressions (for example “emoticons” or “stickers”) in IM chat messages in order to improve the ability to communicate less verbal aspects of a conversation and enhance the interactivity and enjoyment of the conversation.

### SUMMARY

According to one aspect of the present disclosure there is provided a method implemented during a communication event between a plurality of user devices over a communication network. The method comprises identifying a first co-operating element in a first message transmitted from one of said user devices; identifying a second co-operating element in a second message transmitted from one of said user devices; querying a memory to identify an action associated with the combination of the first and at least the second co-operating element; and transmitting a message to each of the plurality of user devices to cause delivery of the action using output means at the plurality of user devices.

According to another aspect of the present disclosure there is provided a computer program product, the computer program product being embodied on a non-transient computer-readable medium and configured so as when executed on one or more processors to perform any of the methods described herein.

According to a further aspect of the present disclosure there is provided a network entity comprising: at least one memory storing information on actions which are to be triggered in response to combinations of co-operating elements; a message builder component configured to analyse messages exchanged over a communication network during a communication event between a plurality of user devices to determine if said messages comprise a co-operating element; and an action controller component configured, in response to determining that said message builder has identified a first co-operating element in a first message transmitted from one of said user devices, and a second co-operating element in a second message transmitted from one of said user devices, to query said memory to identify an action associated with the combination of the first and at least the second co-operating element; wherein the message builder component is configured to transmit a message to each of the plurality of user devices to cause delivery of the action using output means at the plurality of user devices.

According to another aspect of the present disclosure there is provided a user terminal comprising: an output means; at least one memory storing information on actions which are to be triggered in response to combinations of co-operating elements; a network interface configured to transmit and receive messages between the user terminal and one or more further user terminals over a communication network during a communication between the plurality of user terminals; and one or more processors configured to run a communication client application. The communication client application comprises a message builder component configured to analyse messages exchanged over the communication network during the communication event to determine if said messages comprise a co-operating element; and an action controller component configured, in response to determining that said message builder has identified a first co-operating element in a first message transmitted from one of said user terminals, and a second co-operating element in a second message transmitted from one of said user terminals, to query said memory to identify an action associated with the combination of the first and at least the second co-operating element; wherein the message builder component is configured to transmit a message to the one or more further user terminals to cause delivery of the action using output means at the one or more further user terminals, and is further configured to control said output means to deliver the action.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### BRIEF DESCRIPTION OF THE DRAWINGS

For a better understanding of the present disclosure and to show how the same may be put into effect, reference will now be made, by way of example, to the following drawings in which:

FIG. 1 shows a communication system;

FIG. 2 shows a schematic view of a user terminal;

FIG. 3 is a flow chart for a process of triggering an action;

FIG. 4a illustrates a user terminal displaying an action triggered in response to a sequence of stickers being exchanged during a communication event;

FIG. 4b illustrates a user terminal displaying an action triggered in response to a sequence of text portions being entered into messages exchanged during a communication event;

FIG. 4c illustrates a user terminal displaying an action triggered in response to a sequence of character portions being selected during a communication event;

FIG. 4d illustrates a user terminal displaying an action triggered in response to a sequence of screen areas being selected during a communication event; and

FIG. 5 illustrates data flows transmitted during a communication event in accordance with an exemplary embodiment.

### DETAILED DESCRIPTION

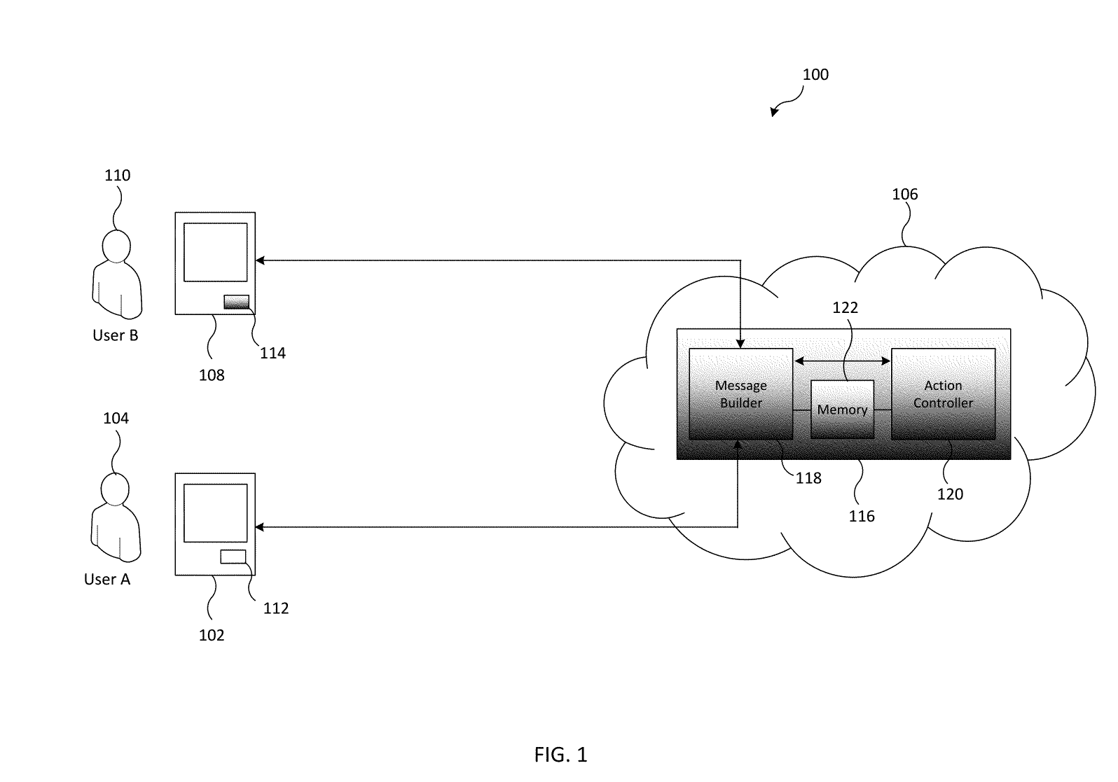

FIG. 1 shows a communication system 100 comprising a first user 104 (User A) who is associated with a first user terminal 102 and a second user 110 (User B) who is associated with a second user terminal 108. The user terminals 102 and 108 can communicate over a communication network 106 in the communication system 100, thereby allowing the users 104 and 110 to communicate with each other over the communication network 106. The communication network 106 may be any suitable network which has the ability to provide a communication channel between the first user terminal 102 and the second user terminal 108. For example, the communication network 106 may be the Internet or another type of network such as a High data rate mobile network, such as a 3^{rd} generation (“3G”) mobile network.

Note that in alternative embodiments, user terminals can connect to the communication network 106 via an additional intermediate network not shown in FIG. 1. For example, if the user terminal 102 is a mobile device, then it can connect to the communication network 106 via a cellular mobile network (not shown in FIG. 1), for example a GSM or UMTS network.

The user terminal 102 may be, for example, a mobile phone, a personal digital assistant (“PDA”), a personal computer (“PC”) (including, for example, Windows™, Mac OS™ and Linux™ PCs), a tablet computer, a gaming device or other embedded device able to connect to the communication network 106. The user terminal 102 is arranged to receive information from and output information to User A 104.

The user terminal 102 executes a communication client application 112, provided by a software provider associated with the communication system 100. The communication client application 112 is a software program executed on a local processor in the user terminal 102. The communication client application 112 performs the processing required at the user terminal 102 in order for the user terminal 102 to transmit and receive data over the communication system 100. The communication client application 112 executed at the user terminal 102 may be authenticated to communicate over the communication system through the presentation of digital certificates (e.g. to prove that user 104 is a genuine subscriber of the communication system—described in more detail in WO 2005/009019).

The user terminal 108 may correspond to the user terminal 102. The user terminal 108 executes, on a local processor, a communication client application 114 which corresponds to the communication client application 112 executed at the user terminal 102. The communication client application 114 at the user terminal 108 performs the processing required to allow User 110 to communicate over the network 106 in the same way that the communication client application 112 at the user terminal 102 performs the processing required to allow the User A 104 to communicate over the network 106. The user terminals 102 and 108 are end points in the communication system. FIG. 1 shows only two users (104 and 110) and two user terminals (102 and 108) for clarity, but many more users and user devices may be included in the communication system 100, and may communicate over the communication system 100 using respective communication clients executed on the respective user devices, as is known in the art.

FIG. 1 shows a network entity (server 116) in the communication network 106 comprising a message builder component 118, an action controller component 120 and a memory 122. Operations performed by the server 116 are controlled by the software provider associated with the communication system 100 (that provides the instances of the communication client application 112 and 114). The functionality of these components is described in further detail later.

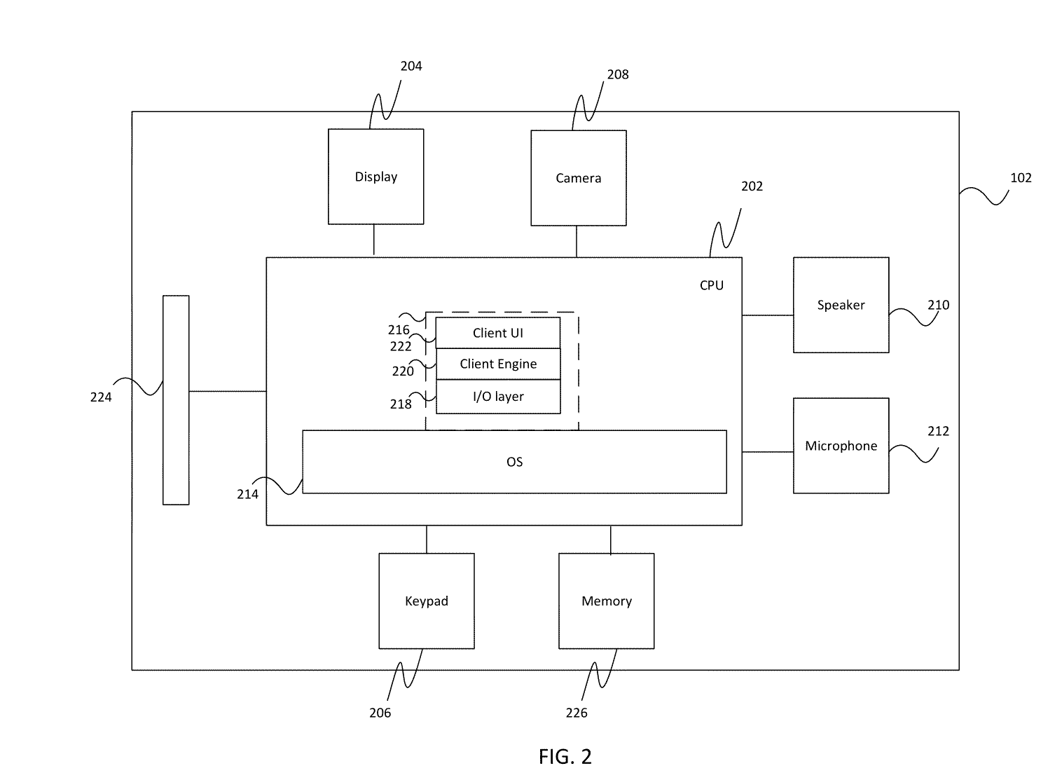

FIG. 2 illustrates a detailed view of the user terminal 102 on which is executed a communication client application for communicating over the communication system 100. The user terminal 102 comprises a central processing unit (“CPU”) 202, to which is connected a display 204 such as a screen or touch screen, input devices such as a keypad 206, a camera 208, and touch screen 204. An output audio device 210 (e.g. a speaker) and an input audio device 212 (e.g. a microphone) are connected to the CPU 202. The display 204, keypad 206, camera 208, output audio device 210 and input audio device 212 may be integrated into the user terminal 102 as shown in FIG. 2. In alternative user terminals one or more of the display 204, the keypad 206, the camera 208, the output audio device 210 and the input audio device 212 may not be integrated into the user terminal 102 and may be connected to the CPU 202 via respective interfaces. One example of such an interface is a USB interface. The CPU 202 is connected to a network interface 224 such as a modem for communication with the communication network 106. The network interface 224 may be integrated into the user terminal 102 as shown in FIG. 2. In alternative user terminals the network interface 224 is not integrated into the user terminal 102. The user terminal 102 also comprises a memory 226 for storing data as is known in the art. The memory 226 may be a permanent memory, such as ROM. The memory 226 may alternatively be a temporary memory, such as RAM.

FIG. 2 also illustrates an operating system (“OS”) 214 executed on the CPU 202. Running on top of the OS 214 is a software stack 216 for the communication client application 112 referred to above. The software stack shows an I/O layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the computer and handles data being transmitted to and from the communication network 106 via the network interface 224. The I/O layer 218 comprises audio and/or video codecs which receive incoming encoded streams and decodes them for output to speaker 210 and/or display 204 as appropriate, and which receive unencoded audio and/or video data from the microphone 212 and/or camera 208 and encodes them for transmission as streams to other end-user terminals of the communication system 100. The client engine layer 220 handles the connection management functions of the VoIP system as discussed above, such as establishing calls or other connections by server-based or P2P address look-up and authentication. The client engine may also be responsible for other secondary functions not discussed herein. The client engine 220 also communicates with the client user interface layer 222. The client engine 220 may be arranged to control the client user interface layer 222 to present information to the user of the user terminal 200 via the user interface of the client which is displayed on the display 204 and to receive information from the user the user terminal 200 via the user interface.

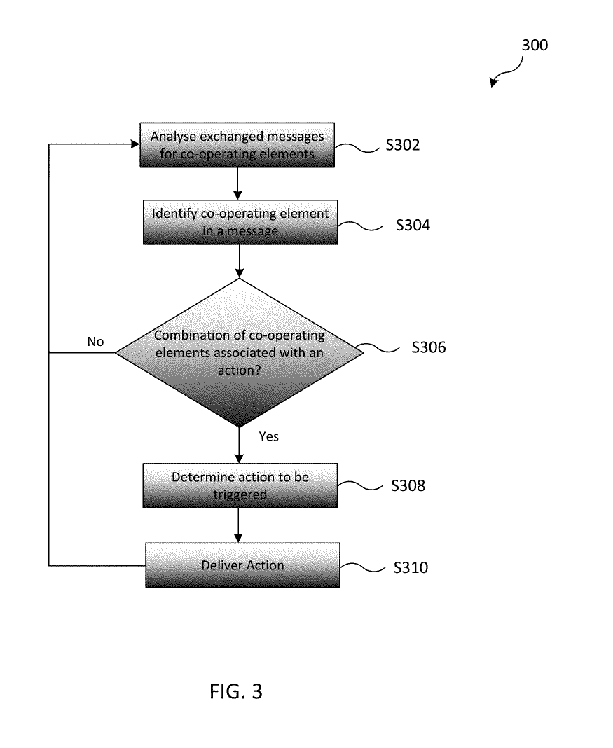

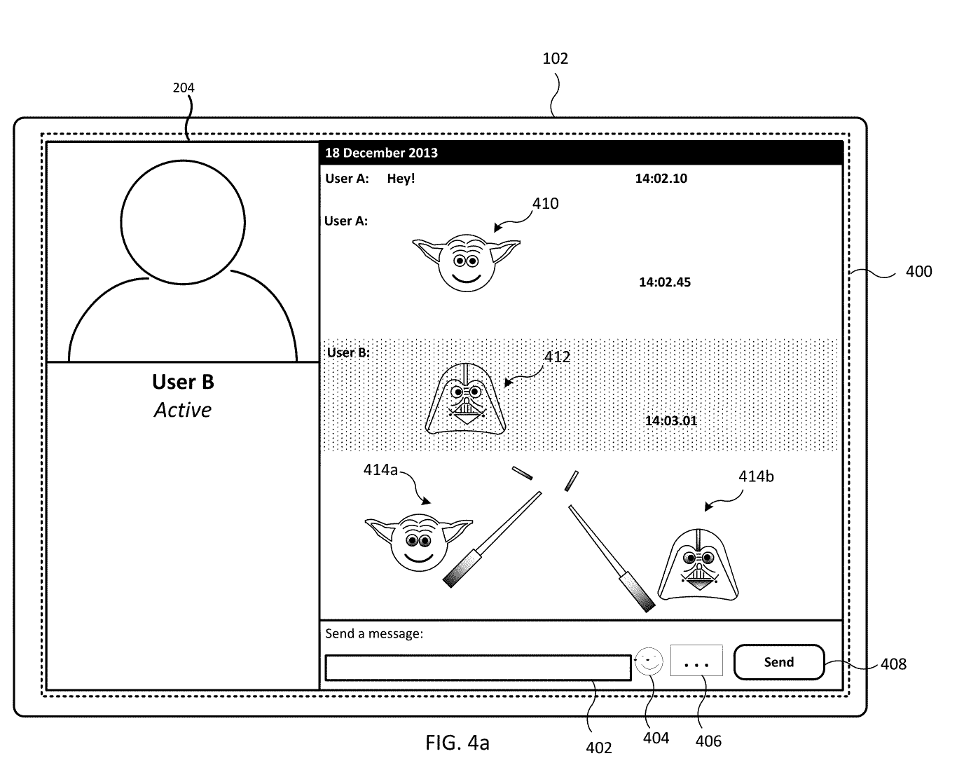

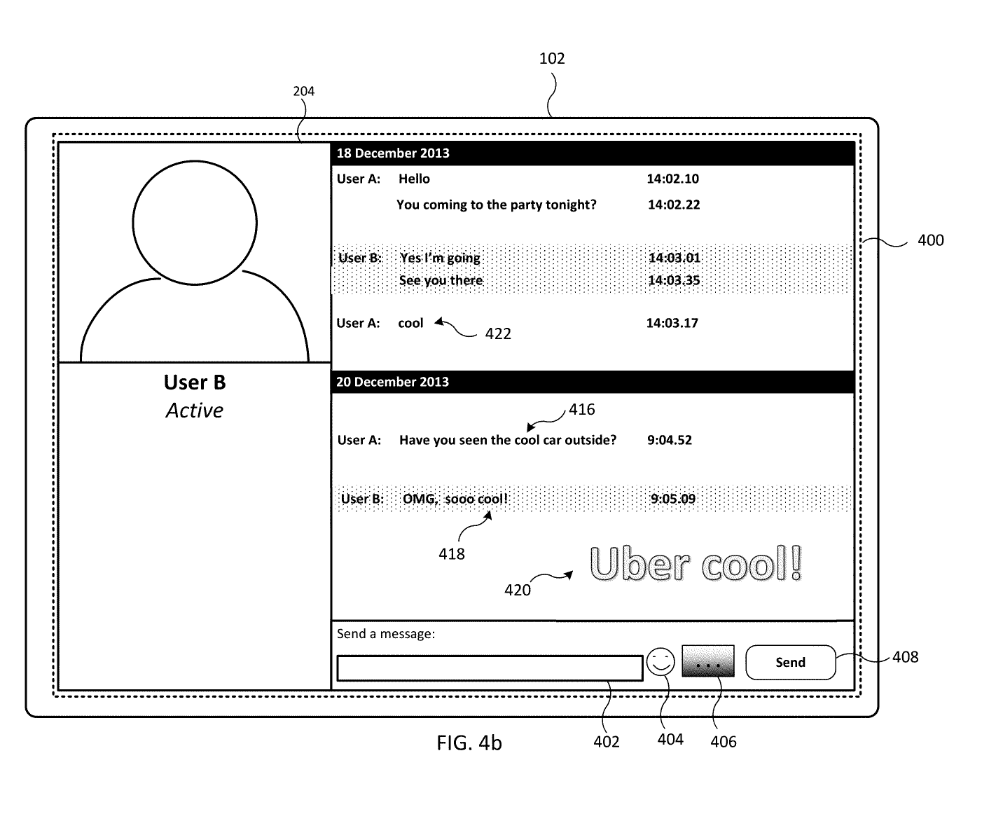

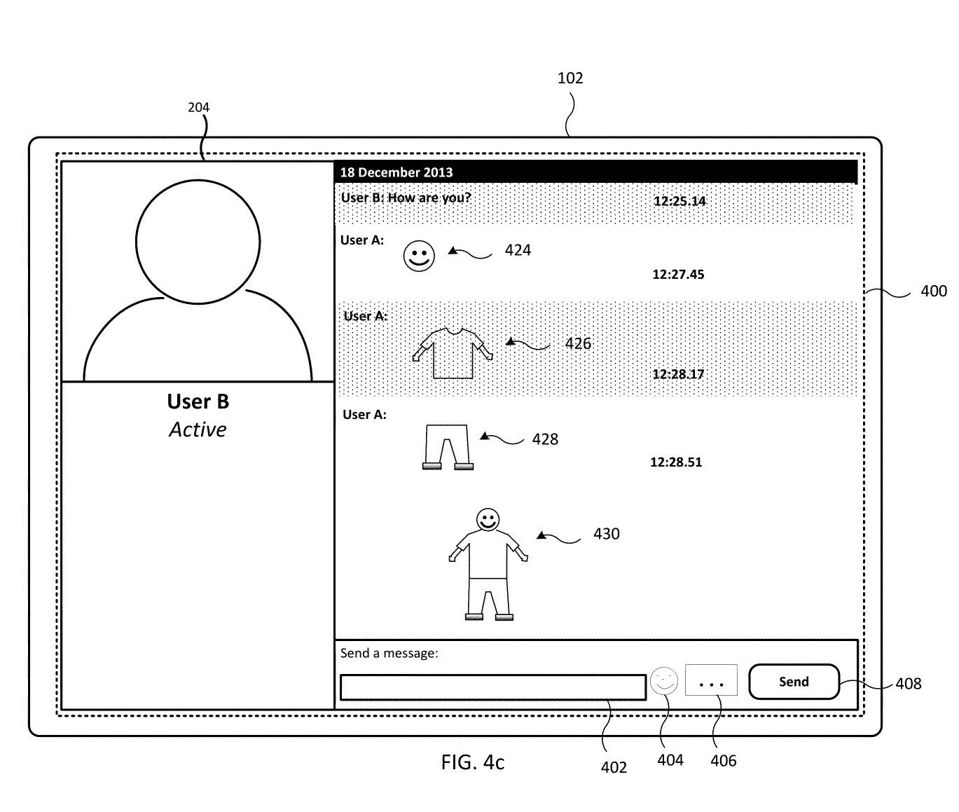

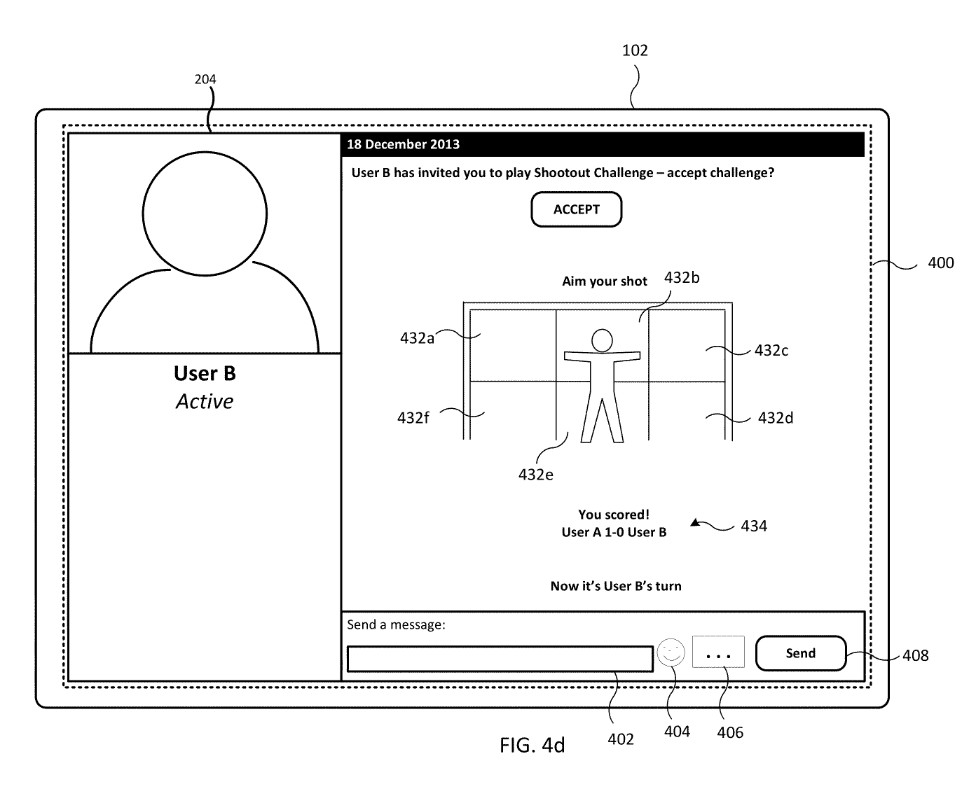

A method implemented during a communication event between a plurality of user devices (otherwise referred to as user terminals herein) over the communications network 106 will now be described with reference to FIG. 3 which is a flow chart for a process 300 of triggering an action. Reference will also be made to FIGS. 4a, 4b, 4c and 4d which illustrate exemplary client user interfaces presented in various embodiments as part of the process 300.

Embodiments of the present disclosure are described with reference to User A 104 and User B 110 engaging in an instant messaging conversation whereby messages are transmitted and received between the first user terminal 102 and the second user terminal 108 in an instant messaging communication session. However embodiments of the present disclosure also extend to other types of communication event as will be described later.

During the instant messaging conversation, messages may be transmitted in both directions (that is from the first user terminal 102 to the second user terminal 108 and vice versa) with User A 104 instigating transmission of new messages in response to receipt of received messages from User B 110 and vice versa. The instant messaging conversation may include more than two users and the instant messages may be transmitted between any of the users in the conversation.

The messages in the communication session are transmitted over the communication network 106. Embodiments of the present disclosure are described below with reference to messages transmitted during a communication event being transmitted via the server 116 connected to the communication network 106 between the first user terminal 102 and the second user terminal 108. Alternatively or additionally, the messages of the communication session may be transmitted on a point-to-point route between the first user terminal 102 and the second user terminal 108 (i.e. a route that does not go via any server in the communication system 100), as is known in the art.

There are a number of co-operating elements that may be transmitted in messages between the first user terminal 102 and the second user terminal 108 via the server 116. At step S302, the server 116 analyses messages received from user terminals during the instant messaging conversation to identify these co-operating elements.

The messages can contain text input by one user at their user terminal for transmission to the other user terminal. The client user interface provided by the communication client application 112 executed on the first user terminal 102 is operable to display text input by the user 102 to be transmitted in a message of the instant messaging communication session but which has not yet been transmitted. Specifically, the client 112 displays via the client user interface a message field (402 in FIGS. 4a, 4b, 4c, and 4d) into which User A 104 is able to enter text using for example the touch screen 204 or keypad 206. The client user interface displays a selectable send option 408 which User A 104 can select after inputting such text. In response, the client 112 creates a message containing the input text and transmits the created message via the communication network 106 to the second user terminal 108. User B 110 can then respond to User A's message in a similar manner, or User A 104 can instigate transmission of a further message in a similar manner without User B 110 responding to User A's earlier message. The co-operating elements may comprise portions of text that are input into a message by one user at their user terminal for transmission to the other user terminal.

The messages can also contain emoticons input by one user at their user terminal for transmission to the other user terminal. Specifically, the client 112 displays via the client user interface an emoticon button (404 in FIGS. 4a, 4b, 4c, and 4d) which User A 104 is able to select using an appropriate input device such as a mouse (not shown in FIG. 2) or using the touch screen 204. In response to detecting selection of the emoticon button 404, the client 112 displays via the client user interface a plurality of emoticons available for insertion into the message field 402. The plurality of emoticons are stored in memory 226. Certain emoticons may be invoked by a user entering a combination of characters/symbols into the message field 402 e.g. a colon symbol “:” followed by a round closing bracket “)”. In response to the user selecting the send option 408, the client detects the selected emoticon or character/symbol combination and displays the selected emoticon or the emoticon corresponding to the entered character/symbol combination (e.g. a “smiley” emoticon, [symbol] ) as a transmitted message. The client 114 at the recipient second user terminal 108 similarly detects the received emoticon or character/symbol combination and displays the emoticon as a received message. The co-operating elements may comprise emoticons, whereby an emoticon is input into a message by one user at their user terminal for transmission to the server 116.

A message may consist of a sticker. In contrast to an emoticon, a sticker is sent as a single media object and cannot be sent in line with text like emoticons. Unlike some emoticons, a sticker cannot be selected by entering in certain characters/symbols in the message field 402. The client 112 may display via the client user interface a dedicated sticker button to enable User A to access a collection of available stickers. Alternatively, the collection of available stickers may be accessed via a menu button 406 or via the emoticon button (404 in FIGS. 4a, 4b, 4c, and 4d). The plurality of stickers are stored in memory 226. The co-operating elements may comprise stickers, whereby a sticker is input into a message by one user at their user terminal for transmission to the other user terminal.

Insertion of emoticons and stickers enable less verbal aspects of a conversation to be communicated, reduce the amount of text that has to be entered to convey a message, and enhance the interactivity and enjoyment of the conversation. Another way to provide such advantages is the insertion of two or more character parts to convey an emotion/expression of a character.

That is, a message may comprise a selected character part (e.g. a head, body or legs). The client 112 may display via the client user interface a dedicated character part button to enable User A to access a collection of available character parts. Alternatively, the collection of available character parts may be accessed via the menu button 406 or via the emoticon button (404 in FIGS. 4a, 4b, 4c, and 4d). For example, User A may navigate a collection of a first set of character parts (e.g. heads) and select a character part from the first set, navigate a collection of a second set of character parts (e.g. bodies) and select a character part from the second set, and navigate a collection of a third set of character parts (e.g. legs) and select a character part from the third set. Whilst in the above example a character is described as being composed of three character parts, it will be appreciated that this is an example and that a character may be composed of two or more character parts. The plurality of character parts are stored in memory 226. The co-operating elements may comprise character parts, whereby a character part is input into a message by one user at their user terminal for transmission to the other user terminal.

A set of emoticons, stickers and/or character parts may be available to a user after the user installs and executes the client software on their device. Further emoticons, stickers and character parts may be downloaded by the user and stored in the memory 226 at a subsequent time.

To increase interactivity and user engagement, User B 110 may initiate a game with User A 104 during a communication event between these users. User B 104 may initiate the game by selecting the menu button 406 and making one or more further selections. In response to detecting initiation of the game, the server 116 is configured to request User A 104 to make a selection of one of a plurality of media objects (e.g. areas of a graphic) displayed using the client user interface provided by the communication client application 112, receive an indication of User A's selected media object in a message, request User B110 to make a selection of one of the plurality of media objects displayed using the client user interface provided by the communication client application 114, receive an indication of User B's selected media object in a message, and provide an outcome of the game to the first user terminal 102 and the second user terminal 108 based on whether User A's selected media object matches User B's selected media object or not. The co-operating elements may comprise the selectable media objects that may be communicated in a message transmitted from a user's user terminal to the other user terminal.

Step S302 is implemented by the message builder 118 analysing messages sent from the first terminal 102 to the second terminal 108, and messages sent from the second terminal 108 to the first terminal 102 during the instant messaging conversation. The communication client applications 112 and 114 are configured to exchange messages in accordance with a text-based messaging protocol. That is, each co-operating element referred to above corresponds to a portion of text. The portion of text may comprise one or more alphabetic characters, and/or one or more numeric characters, and/or one or more symbols. This portion of text may be text that is input a message by one user at their user terminal for transmission to the other user terminal. Alternatively the portion of text may be assigned to the co-operating element for identification of the co-operating element. For example each emoticon, sticker and character part stored in memory 226 has an associated portion of text to identify the co-operating element. Similarly, each of the selectable media objects in the game referred to above has an associated portion of text to identify the co-operating element. A portion of text assigned to a co-operating element may comprise a Uniform Resource Indicator (URI).

The portions of text corresponding to co-operating elements are stored in the memory 122. The message builder 118 has access to the memory 122, and queries the memory 122 to determine if a message exchanged between the user terminals 102 and 108 comprises a co-operating element.

In response to identifying a co-operating element in a message received from the first user terminal 102 or the second user terminal 108 at step S304, the message builder 118 supplies an indication of the identified co-operating element to the action controller 120 for evaluation by the action controller 120.

The action controller 120 is coupled to a memory which stores information on actions which are to be triggered in response to combinations of co-operating elements. For example, the memory 122 may store the information on actions which are to be triggered in response to combinations of co-operating elements in addition to the portions of text corresponding to co-operating elements.

The actions which are to be triggered in response to combinations of co-operating elements are configured by the software provider associated with the communication system 100 (that provides the instances of the communication client application 112 and 114). An action may be triggered in response to two or more co-operating elements being identified in messages exchanged during a communication event between the first user terminal 102 and the second user terminal 108 (the action defined in memory 122). Certain actions may only be triggered based on a certain sequence (in time) of co-operating elements. Whilst other actions are triggered based on a combination of co-operating elements, regardless of the sequence of the co-operating elements. Furthermore, an action may be triggered in dependence on the whether the same user or different users transmitted the messages comprising the two or more co-operating elements. For example if User A 104 transmits a message comprising a co-operating element ‘x’ from the first user terminal 102 to the second user terminal 108, and then User B 110 transmits a message comprising a co-operating element ‘y’ from the second user terminal 108 to the first user terminal 102 then an action ‘z’ may be triggered (defined in memory 122). However if User A 104 transmits a message comprising a co-operating element ‘x’ from the first user terminal 102 to the second user terminal 108, and then transmits a message comprising a co-operating element ‘y’ to the second user terminal 108 then a different action ‘w’ may be triggered (defined in memory 122).

The information on the actions which are to be triggered in response to combinations of co-operating elements may take the form of a decision tree indicating actions to be triggered based on different combinations of co-operating elements. This decision tree indicating which action is to be triggered based on the identified combination of co-operating elements may be multi-layered in the sense that if a combination of co-operating elements is detected that is associated with an action, the action to be triggered is dependent on what actions have been previously been triggered during the communication event.

Each time the action controller 120 receives an indication of an identified co-operating element from the message builder 118, the action controller 120 is configured to determine at step S306 whether the combination of the identified co-operating element and one or more previously identified co-operating elements is associated with an action by querying the memory 122 coupled to the action controller 120.

If it is determined at step S306 that the combination of the identified co-operating element and one or more previously identified co-operating elements is not associated with an action, the action controller 120 takes no further action and the message builder 118 continues analysing messages received from user terminals during the communication event to identify co-operating elements, as represented by the process 300 proceeding back to step S302.

If it is determined at step S306 that the combination of the identified co-operating element and one or more previously identified co-operating elements is associated with an action, the process proceeds to step S308.

At step S308, the action controller 120 determines the action to be triggered based on the combination of the identified co-operating element and one or more previously identified co-operating elements by querying the memory 122 coupled to the action controller 120. Step S308, may comprise determining whether the same user or different users transmitted the messages comprising the two or more co-operating elements in order to determine the action to be triggered, The action controller 120 then communicates the action to be triggered based on the combination of the identified co-operating element and one or more previously identified co-operating elements, to the message builder 118.

The process 300 then proceeds to step S310 where the message builder 118 composes messages to be transmitted to the first user terminal 102 and the second user terminal 108 based on the action to be triggered, and transmits the composed messages to the first user terminal 102 and the second user terminal 108 at step S310.

The messages transmitted to the first user terminal 102 and the second user terminal 108 comprise a portion of text which when received by the communication client application at the respective user terminal cause delivery of the action using output means at the first user terminal 102 and the second user terminal 108. The action may comprise display of at least one media object on a display of the first user terminal 102 and the second user terminal 108. Alternatively or additionally, the action may comprise outputting an audio signal using speakers 210 of each the first user terminal 102 and the second user terminal 108.

After transmitting the messages at step S310, the message builder 118 continues analysing messages received from user terminals during the communication event to identify co-operating elements, as represented by the process 300 proceeding back to step S302.

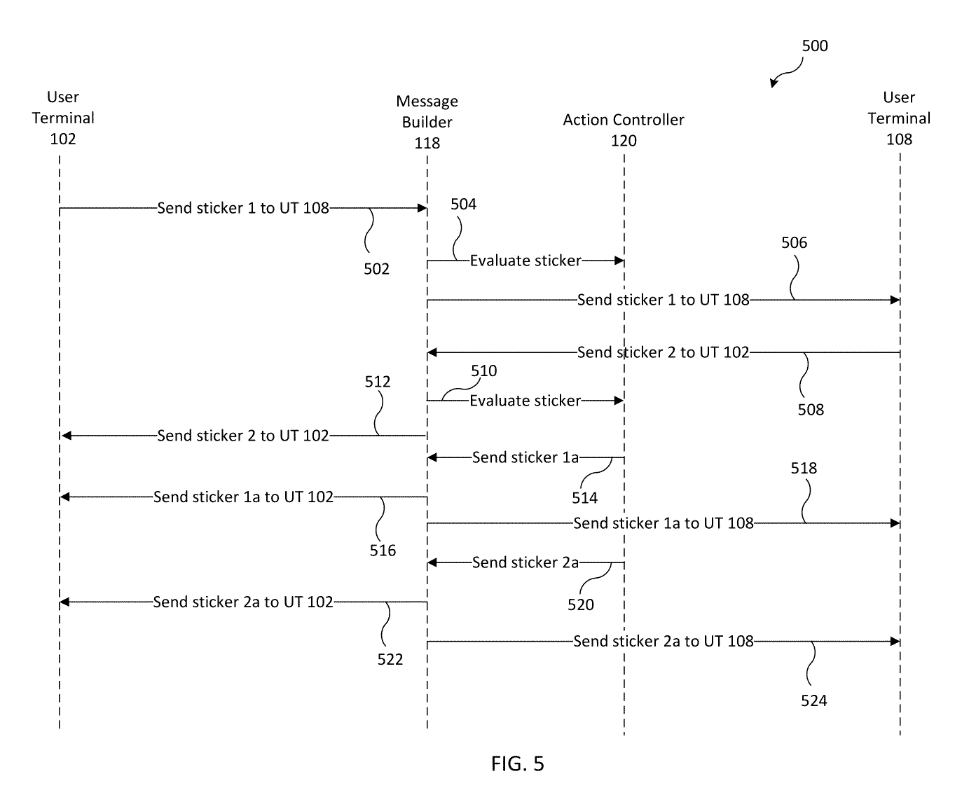

To illustrate how an action may be delivered to the user terminals in one exemplary embodiment using the process 300, reference is made to the client user interface displayed on the first user terminal 102 illustrated in FIG. 4a and a signalling chart 500 shown in FIG. 5 illustrating the data flows transmitted during an instant messaging session.

As shown in FIG. 4a transmitted and received messages of an instant messaging session taking place on an exemplary date of 18 Dec. 2013 between User A 104 and User B 110 are displayed on User A's display 204. The client user interface displays content—including the transmitted and received messages—in an available area 400 of the display 204.

During the instant messaging session User A 104 selects a Yoda sticker 410 (sticker 1) for transmission to User B 110 at the second user terminal 108 and selects the send option 408 to send the selected sticker to User B 110 at the second user terminal 108. In response to detecting the selection of the send option 408 to send the selected sticker to User B 110 at the second user terminal 108, the communication client application 112 determines from memory 226 on the first user terminal 102 the portion of text assigned to sticker 1 (the co-operating element) and transmits a message 502 comprising the portion of text over the communication network 106 to the server 116.

In response to transmitting the message 502 over the communication network 106 to the server 116, the client user interface provided by the communication client application 112 displays sticker 1 410 as a transmitted message (as shown in FIG. 4a).

The message builder 118 identifies that the message 502 comprises a co-operating element based on querying the memory 122 with the portion of text assigned to sticker 1 410, and supplies an indication 504 of the identified co-operating element (sticker 1) to the action controller 120 for evaluation.

As sticker 1 410 was the first co-operating element transmitted in a message exchanged between the first user terminal 102 and the second user terminal 108, the action controller 120 determines at step S306 that there is no combination of co-operating elements, and therefore takes no further action.

The message builder 118 transmits a message 506 comprising the portion of text assigned to sticker 1 (the co-operating element) over the communication network 106 to the second user terminal 108. In response to receiving the message 506, the communication client application 114 determines from the memory 226 on the second user terminal 108 the sticker 1 (the co-operating element) assigned to the portion of text in the message 506 and the client user interface provided by the communication client application 114 displays sticker 1 410 as a received message (not shown in FIG. 4a).

During the instant messaging session User B 110 selects a Darth Vader sticker 412 (sticker 2) for transmission to User A 102 at the first user terminal 102 and selects the send option 408 to send the selected sticker to User A 102 at the first user terminal 102. In response to detecting the selection of the send option 408 to send the selected sticker to User A 102 at the first user terminal 102, the communication client application 114 determines from memory 226 on the second user terminal 108 the portion of text assigned to sticker 2 (the co-operating element) and transmits a message 508 comprising the portion of text over the communication network 106 to the server 116.

In response to transmitting the message 508 over the communication network 106 to the server 116, the client user interface provided by the communication client application 114 displays sticker 2 412 as a transmitted message (not shown in FIG. 4a).

The message builder 118 identifies that the message 508 comprises a co-operating element based on querying the memory 122 with the portion of text assigned to sticker 2 412, and supplies an indication 510 of the identified co-operating element (sticker 2) to the action controller 120 for evaluation.

The message builder 118 transmits a message 512 comprising the portion of text assigned to sticker 2 (the co-operating element) over the communication network 106 to the first user terminal 102. In response to receiving the message 512, the communication client application 112 determines from the memory 226 on the first user terminal 102 the sticker 2 (the co-operating element) assigned to the portion of text in the message 512 and the client user interface provided by the communication client application 112 displays sticker 2 412 as a received message (as shown in FIG. 4a).

The memory 122 stores information on an action which is to be triggered in response to the combination of the sticker 1 410 and the sticker 2 412. Thus in response to receiving the indication 510 of the identified co-operating element (sticker 2) from the message builder 118, the action controller 120 determines the action to be triggered based on the combination of the sticker 1 410 and the sticker 2 412 at step S308 by querying the memory 122 coupled to the action controller 120. The determined action in this exemplary embodiment is for animated versions of the sticker 1 410 and the sticker 2 412 to be displayed on both the first user terminal 102 and the second user terminal 108.

The action controller 120 transmits a message 514 to the message builder 118 indicating that an animated version of the sticker 1 410 should be transmitted to both the first user terminal 102 and the second user terminal 108, the message 514 comprising a portion of text assigned to a sticker 1a 414a (animated version of sticker 1 410). In response to receiving message 514, the message builder 118 transmits a message 516 over the communication network 106 to the first user terminal 102 and a message 518 over the communication network 106 to the second user terminal 108, the message 516 and the message 518 comprising the portion of text assigned to sticker 1a 414a (animated version of sticker 1 410).

The action controller 120 further transmits a message 520 to the message builder 118 indicating that an animated version of the sticker 2 412 should be transmitted to both the first user terminal 102 and the second user terminal 108, the message 520 comprising a portion of text assigned to a sticker 1a 414b (animated version of sticker 2 412). In response to receiving message 520, the message builder 118 transmits a message 522 over the communication network 106 to the first user terminal 102 and a message 524 over the communication network 106 to the second user terminal 108, the message 522 and the message 524 comprising the portion of text assigned to sticker 2a 414b (animated version of sticker 2 412).

In response to receiving the message 516, the communication client application 112 determines from the memory 226 on the first user terminal 102 the sticker 1a 414a assigned to the portion of text in the message 516. In response to receiving the message 522, the communication client application 112 determines from the memory 226 on the first user terminal 102 the sticker 2a 414b assigned to the portion of text in the message 522. The client user interface provided by the communication client application 112 displays the animated sticker 1a 414a and the animated sticker 2a 414b as a received message (as shown in FIG. 4a). The combination of the animated sticker 1a 414a and the animated sticker 2a 414b provides a battle animation between the two character stickers 414a, 414b. The communication client application 114 functions in the same manner in response to receiving messages 518 and 524.

Whilst in the exemplary embodiment described above the action associated with the sticker 1 410 and the sticker 2 412 is for animated versions of the sticker 1 410 and the sticker 2 412 to be displayed on both the first user terminal 102 and the second user terminal 108, this is merely an example. Other actions may be configured, by the software provider associated with the communication system 100, to be triggered in response to the combination of sticker 1 410 and sticker 2 412.

Whilst FIG. 4a and FIG. 5 has been described above with reference to two users transmitting messages each comprising a co-operating element, the same principles apply if a single user transmitted separated messages each comprising a co-operating element.

Whilst FIG. 4a and FIG. 5 has been described above with reference to co-operating elements being stickers, the same principles apply when the identified co-operating elements are emoticons. Other actions that may be delivered to the first user terminal 102 and the second user terminal 108 in response to a combination of co-operating elements in messages exchanged between the first user terminal 102 and the second user terminal 108 are now described with reference to FIGS. 4b-d.

As shown in FIG. 4b transmitted and received messages of an instant messaging session taking place on an exemplary date of 20 Dec. 2013 between User A 104 and User B 110 are displayed on User A's display 204. The client user interface displays content—including the transmitted and received messages—in an available area 400 of the display 204.

In this example, the memory 122 stores information on an action to be triggered in response to a combination of text portions (that is input a message by one user at their user terminal for transmission to the other user terminal) being present in separate messages exchanged between User A 104 and User B 110. In particular that a graphical icon “uber cool!” be displayed in the client user interfaces provided by the communication client applications 112,114 in response to identifying the word “cool” in two separate messages transmitted between the first user terminal 102 and the second user terminal 108.

User A 104 enters text comprising the word “cool” into the message field 402 using input means on the first user terminal 102 and selects selectable send option 408 after inputting such text. In response, the communication client application 112 creates a message containing the input text and transmits the created message via the communication network 106 to the server 116 for delivery to the second user terminal 108. As shown in FIG. 4b, the client user interface provided by the communication client application 112 displays the text input by User A as a sent message comprising the word cool 416.

In reply, User B 110 enters text comprising the word “cool” into the message field 402 using input means on the second user terminal 108 and selects selectable send option 408 after inputting such text. In response, the communication client application 114 creates a message containing the input text and transmits the created message via the communication network 106 to the server 116 for delivery to the first user terminal 102. The server 116 transmits a message containing the input text to the first user terminal 102. As shown in FIG. 4b, the client user interface provided by the communication client application 112 displays the received message comprising the word cool 418.

In response to receiving indications of the identified co-operating elements 416,418 from the message builder 118, the action controller 120 determines the action to be triggered based on the combination of the text portions 416,418 by querying the memory 122 coupled to the action controller 120.

The action controller 120 transmits a message to the message builder 118 indicating that a graphical icon “uber cool!” should be transmitted to both the first user terminal 102 and the second user terminal 108. In response to receiving this message, the message builder 118 transmits a message over the communication network 106 to the first user terminal 102 comprising a portion of text assigned to the graphical icon “uber cool!”, and a message over the communication network 106 to the second user terminal 108 comprising a portion of text assigned to the graphical icon “uber cool!”.

In response to receiving this message from the message builder 518, the communication client application 112 determines from the memory 226 on the first user terminal 102 the graphical icon “uber cool!” 420 assigned to the portion of text in the message and the client user interface provided by the communication client application 112 displays the graphical icon “uber cool!” 420 as a received message (as shown in FIG. 4b). The communication client application 114 functions in the same manner in response to receiving the message comprising a portion of text assigned to the graphical icon “uber cool!”.

Whilst it has been described above that an action is triggered in response identifying the same text portion (“cool”) in two separate messages transmitted between the first user terminal 102 and the second user terminal 108, other actions may be triggered in response to identifying a combination of different portions of text transmitted in separate messages between the first user terminal 102 and the second user terminal 108.

Whilst FIG. 4b has been described above with reference to two user transmitting messages comprising co-operating elements, the same principles apply if a single user transmitted separated messages each comprising a co-operating element.

Referring now to FIG. 4c, User A 104 is able to convey an emotion/expression during a communication event by transmitting a character to User B 110.

In this example, the memory 122 stores information on an action to be triggered in response to a combination of character parts (selected by one or more users of the communication event.

User A 104 may navigate a collection of a first set of character parts (e.g. heads) and select a character part (head) from the first set and selects the send option 408. In response to detecting the selection of the send option 408 to send the selected head to User B 110 at the second user terminal 108, the communication client application 112 determines from memory 226 on the first user terminal 102 the portion of text assigned to the selected head (the co-operating element) and transmits a message comprising the portion of text over the communication network 106 to the server 116 for delivery to the second user terminal 108. As shown in FIG. 4c, the client user interface provided by the communication client application 112 displays the head 424 selected by User A as a sent message.

User A may then navigate a collection of a second set of character parts (e.g. bodies) and select a character part (body) from the second set and selects the send option 408. In response to detecting the selection of the send option 408 to send the selected body to User B 110 at the second user terminal 108, the communication client application 112 determines from memory 226 on the first user terminal 102 the portion of text assigned to the selected body (the co-operating element) and transmits a message comprising the portion of text over the communication network 106 to the server 116 for delivery to the second user terminal 108. As shown in FIG. 4c, the client user interface provided by the communication client application 112 displays the body 426 selected by User A as a sent message.

User A may then navigate a collection of a third set of character parts (e.g. legs) and select a character part (legs) from the third set and selects the send option 408. In response to detecting the selection of the send option 408 to send the selected legs to User B 110 at the second user terminal 108, the communication client application 112 determines from memory 226 on the first user terminal 102 the portion of text assigned to the selected legs (the co-operating element) and transmits a message comprising the portion of text over the communication network 106 to the server 116 for delivery to the second user terminal 108. As shown in FIG. 4c, the client user interface provided by the communication client application 112 displays the legs 428 selected by User A as a sent message.

In response to receiving indications of the identified co-operating elements 424,426,428 from the message builder 118, the action controller 120 determines the action to be triggered based on the combination of the character parts 424,426,428 by querying the memory 122 coupled to the action controller 120.

The action controller 120 transmits a message to the message builder 118 indicating that a composite image should be transmitted to both the first user terminal 102 and the second user terminal 108. In response to receiving this message, the message builder 118 transmits a message over the communication network 106 to the first user terminal 102 comprising a portion of text assigned to the composite image and a message over the communication network 106 to the second user terminal 108 comprising a portion of text assigned to the composite image.

In response to receiving this message from the message builder 518, the communication client application 112 determines from the memory 226 on the first user terminal 102 the composite image 430 assigned to the portion of text in the message and the client user interface provided by the communication client application 112 displays the composite image 430 as a received message (as shown in FIG. 4c). The communication client application 114 functions in the same manner in response to receiving the message comprising a portion of text assigned to the composite image.

Whilst it has been described above that the character parts that trigger an action are selected by a single user (User A), the character parts to trigger the action may be selected by two or more users during the communication event. Furthermore, whilst the action of merely displaying a composite image has been described above, other actions may be triggered based on a combination of character parts being identified in messages exchanged between the first user terminal 102 and the second user terminal 108, for example an animated character made up of the selected character parts may be displayed by the communication clients applications 112,114.

By providing the sets of character parts in separate collections that are accessible to a user, the communication client application 112,114 minimises the number of selection options that are presented to a user. This is particularly advantageous for mobile devices where the screen size is limited.

Referring now to FIG. 4d, User A 104 and User B 110 may take part in a game during a communication event between these users.

In this example, the memory 122 stores information on an action to be triggered in response to options selected by User A 104 and User B 110 during the game matching, and information on an action to be triggered in response to media objects selected by User A 104 and User B 110 during the game not matching.

To increase interactivity and user engagement during the instant messaging session, User B 110 may initiate a game with User A 104 during the instant messaging session.

In response to the communication client application 112 detecting acceptance of the invitation to the game, the client user interface provided by the communication client application 112 displays a plurality of selectable media objects 432a-f. The client user interface provided by the communication client application 114 also displays a plurality of selectable media objects 432a-f on the second user terminal 108 to User B. As a mere example, the selectable media objects 432a-f may be display areas corresponding to portions of a soccer goal.

Acting as a penalty taker in the game, User A 104 selects one of the plurality of selectable media objects 432a-f where he wants to shoot the ball. In response to detecting the selection of one of the plurality of selectable media objects 432a-f by User A 104, the communication client application 112 determines from memory 226 on the first user terminal 102 the portion of text assigned to the selected selectable media object (the co-operating element) and transmits a message comprising the portion of text over the communication network 106 to the server 116.

Acting as a goalkeeper in the game, User B 110 selects one of the plurality of selectable media objects 432a-f where he wants to attempt to catch the ball. In response to detecting the selection of one of the plurality of selectable media objects 432a-f by User B 110, the communication client application 114 determines from memory 226 on the second user terminal 108 the portion of text assigned to the selected selectable media object (the co-operating element) and transmits a message comprising the portion of text over the communication network 106 to the server 116.

In response to receiving indications of the selected co-operating elements 432 from the message builder 118, the action controller 120 determines the action to be triggered based on the combination of the selectable media objects by querying the memory 122 coupled to the action controller 120.

If the portion of text assigned to the selectable media object selected by User A 104 matches the portion of text assigned to the selectable media object selected by User B 110, the action controller determines that an indication should be delivered to the first user terminal 102 and the second user terminal 108 indicating that User B saved User A's shot.

In contrast, if the portion of text assigned to the selectable media object selected by User A 104 does not match the portion of text assigned to the selectable media object selected by User B 110, the action controller 120 determines that an indication should be delivered to the first user terminal 102 and the second user terminal 108 indicating that User A scored a goal.

Upon instruction from the action controller 120, the message builder 118 transmits a message over the communication network 106 to the first user terminal 102 to indicate an outcome in the game to User A 104 and a message over the communication network 106 to the second user terminal 108 to indicate the outcome in the game to User B 110. The messages transmitted from the message builder 118 to the first user terminal 102 and the second user terminal 108 comprise a portion of text used to convey the outcome in the game.

In response to receiving this message from the message builder 518, the communication client application 112 determines from the memory 226 on the first user terminal 102 what is to be output to User A based on the portion of text in the message. The client user interface provided by the communication client application 112 provides the outcome in the game to User A based on the portion of text in the received message. For example, in response to receiving this message from the message builder 518, the communication client application 112 may display a message 434 in the client user interface to User A 104. Alternatively, the communication client application 112 may determine from the memory 226 that a graphical image assigned to the portion of text in the message, or an animation assigned to the portion of text in the message is to be displayed in the client user interface to User A 104. The communication client application 114 functions in the same manner in response to receiving the message comprising a portion of text used to convey the outcome in the game.

The portions of text used to convey the outcome in the game to User A and User B may be the same. For example the portion of text may correspond to a score “User A 1-0 User B” that is displayed by the client user interfaces provided by the communication client applications 112,114. In another example the portion of text may correspond to animation of goalkeeper saving (or not saving) the penalty that is displayed by the client user interfaces provided by the communication client applications 112,114.

Alternatively of text used to convey the outcome in the game to User A and User B may be different. For example in response to receiving the message from the message builder 518, the communication client application 112 may display a first message in the client user interface to User A 104 e.g. “You scored! User A 1-0 User B”, whereas in response to receiving the message from the message builder 518, the communication client application 114 may display a second message in the client user interface to User B 110 e.g. “You didn't save the shot! User A 1-0 User B”.

Once the action is delivered, the game continues by User A 104 and User B 110 switching roles in the game.

In all of the above described embodiments, the action that is delivered to the users of the communication event is not chosen or preselected by any user in the communication event. That is, the action which is delivered at a terminal of a user in the communication event is unexpected to the user. This is due to the fact that the actions which are to be triggered in response to combinations of co-operating elements (stored in memory 122) are configured by the software provider associated with the communication system 100, thus the behaviour of the action controller 120 is hidden to the user of the communication system 100.

A message transmitted from a user terminal during a communication event may comprise a transmission-time timestamp (generated for the message prior to transmission). The information on an action which is to be triggered in response to a certain combination of co-operating elements (stored in the memory 122) may specify that the action only be triggered if the co-operating elements are identified within messages transmitted within a certain timeframe.

This illustrated in FIG. 4b wherein in an example instant messaging session taking place on an exemplary date of 18 Dec. 2013 between User A 104 and User B 110, User A 104 transmits a message comprising the word “cool” 422 which is identified as co-operating element by the message builder 118.

The memory 122 may store information specifying that a graphical icon “uber cool!” 420 only be displayed in the client user interfaces provided by the communication client applications 112,114 if a second message comprising the word “cool” is identified based on its transmission-time timestamp as being transmitted between the first user terminal 102 and the second user terminal 108 within a predetermined time period (for example 6 hours) of a first message comprising the word “cool” being transmitted between the first user terminal 102 and the second user terminal 108.

Thus, in a subsequent instant messaging session taking place on an exemplary date of 20 Dec. 2013 between User A 104 and User B 110, User A 104 transmits a message comprising the word “cool” 416 which is identified as co-operating element by the message builder 118. However due to the time based element of the action trigger the graphical icon “uber cool!” 420 is not delivered the first user terminal 102 and the second user terminal 108 after User A 104 transmits the message comprising the word “cool” 416. This is shown in FIG. 4b.

Whilst this is described above with reference to FIG. 4b, actions triggered in response to combinations of other co-operating elements referred to hereinabove may also only be triggered if the co-operating elements are identified within separate messages transmitted within a certain timeframe.

Whilst all of the embodiments described above refer to an action comprising the display of at least one media object on a display of a user terminal (for example the display of a sticker, animated sticker, graphical icon, character, animated character, text based message). Additionally or alternatively, an action may comprise output of an audio signal using speakers 210 of a user terminal. That is, a message transmitted to a user terminal to cause delivery of an action may comprise a portion of text which when received by the communication client application at the respective user terminal, causes the communication client application to determines from the memory 226 an audio file assigned to the portion of text to be output using speakers 210 of the user terminal.

The software provider may update the client software, e.g. to introduce new and/or improved functionality in a new version of the client software. Therefore the communication client application 112 may have a different version and/or build number than communication client application 114. The build number of the client increments for each change to the code of the client software. The version number of the client increments when the functionality of the client changes. A change to the build number generally signifies a smaller change to the client software than a change to the version number. In this way, the build numbers may be considered to be sub-divisions of the version numbers.

During establishment of a communication client, the communication applications 112,114 are configured to exchange communication client type information (i.e. version and/or build number). If the server 116 detects that an action should be delivered to a user terminal on which a communication client application is executed that is of a type that doesn't support the delivery of the action, the message builder 118 may transmit a message to the user terminal which is displayed on the user terminal in the client user interface, the message inviting the user to update their client software. For example the message may comprise a web link which the user can select to initiate download of the latest client software.

In the embodiments described above, the server 116 is configured to transmit a message comprising a co-operating element that triggers an action to a recipient terminal such that the co-operating element that triggers the action is displayed at the recipient terminal. For example the communication client application on a recipient terminal is configured to display the legs 428 which triggers the composite image 430 to be displayed). Similarly, the communication client application on a recipient terminal is configured to display the sticker 2 412 which triggers the animated stickers 414a and 414b to be displayed. In alternative embodiments, in response to identifying a message comprising a co-operating element that triggers an action, the server 116 is configured not to transmit that message onto the recipient terminal, instead transmits a message to the recipient terminal to cause delivery of the action (as per the above described embodiments). For example with reference to FIG. 5, the message 512 would not be sent to the first user terminal 102.

Whilst it has been described above that the memory 122 stores the information on actions which are to be triggered in response to combinations of co-operating elements in addition to the portions of text corresponding to co-operating elements. Alternatively a dedicated memory (not shown in FIG. 1) coupled to the action controller 120 may store the information on actions which are to be triggered in response to combinations of co-operating elements.

Whilst FIG. 1 shows a single server 116 in the communication network 106, the functionality of the message builder 118 and action controller 120 may be distributed over a plurality of computing devices (e.g. servers) connected to the communication network 106, for example in a “cloud computing” environment.

As described above, messages exchanged in a communication event between the first user terminal 102 and the second user terminal 108 may be transmitted on a point-to-point route and not via the server 116. The functionality of the server 116 may be implemented by a communication client application executed on one of the user terminals involved in the communication event. In this alternative embodiment, one or more memories on the user terminal stores the portions of text corresponding to co-operating elements and the information on actions which are to be triggered in response to combinations of co-operating elements (for example memory 226).

Embodiments of the present disclosure are described above with reference to User A 104 and User B 110 engaging in an instant messaging conversation. The client user interface displays content—including the transmitted and received messages—in an available area 400 of the display 204. As depicted in FIGS. 4a, 4b, 4c, and 4d, the available area of the display is the whole of the display. However, it is envisaged that the available area of the display (that is the area available to the client 108) may constitute only a portion of the display e.g. with the remainder of the display being used by the operating system and/or other application(s) executed thereon to display other content.

Whilst embodiments of the present disclosure are described with reference to User A 104 and User B 110 engaging in an instant messaging conversation, embodiments of the present disclosure also extend to other types of communication event, examples of which are referred to above. For example, during a video call between User A 104 and User B 110, User A 104 may select to transmit a first emoticon to User B 110 during the video call, and User B 110 may subsequently select to transmit a select an emoticon to User A 104 during the video call. If the first emoticon and the second emoticon are co-operating elements associated with an action (for example display a third emoticon), in accordance with embodiments of the present disclosure the server 116 will transmit messages to the first user terminal 102 and the second user terminal 108 to cause display of the third emoticon in the client user interface provided by the communication client applications 112,114 during the video call.

The steps shown separately in FIG. 3 may or may not be implemented as separate steps.

Generally, any of the functions described herein can be implemented using software, firmware, hardware (e.g., fixed logic circuitry), or a combination of these implementations. The terms “controller”, “functionality”, “component”, and “application” as used herein generally represent software, firmware, hardware, or a combination thereof. In the case of a software implementation, the controller, functionality, component or application represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals may also include an entity (e.g. software) that causes hardware of the user terminals to perform operations, e.g., processors functional blocks, and so on. For example, the user terminals may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method implemented during a communication event between a plurality of user devices over a communication network, the method comprising:
identifying a first co-operating element in a first message transmitted from one of said user devices;
identifying a second co-operating element in a second message transmitted from one of said user devices;
querying a memory to identify an action associated with the combination of the first and at least the second co-operating element; and
transmitting a message to each of the plurality of user devices to cause delivery of the action using output means at the plurality of user devices.

2. The method according to claim 1, the method further comprising identifying one or more further co-operating element in respective one or more further messages transmitted from one of said user devices, the action associated with the combination of the first co-operating element, the second co-operating element and the one or more further co-operating element.

3. The method according to claim 1, wherein the action is identified in dependence on one or more other actions previously identified during the communication event.

4. The method according to claim 1, further comprising:
determining that the action is to be delivered only if the first and at least the second co-operating element are identified as being in messages transmitted within a predetermined time period;
performing said transmitting only if the first and at least the second co-operating element are identified as being in messages transmitted within the predetermined time period.

5. The method according to claim 4, the method comprising identifying the first and at least the second co-operating element as being in messages transmitted within the predetermined time period based on time stamps identified in each of said messages.

6. The method according to claim 1, further comprising:
determining that the action is to be delivered only if the first and at least the second co-operating element are identified as being in messages transmitted within a predetermined sequence;
performing said transmitting only if the first and at least the second co-operating element are identified as being in messages transmitted within said predetermined sequence.

7. The method according to claim 1, wherein the first co-operating element comprises a first instant messaging sticker and the second co-operating element comprises a second instant messaging sticker.

8. The method according to claim 1, wherein the first co-operating element comprises a first emoticon and the second co-operating element comprises a second emoticon.

9. The method according to claim 1, wherein the first co-operating element comprises a first character part and the second co-operating element comprises a second character part.

10. The method according to claim 1, wherein the first co-operating element comprises a first media object selected in a game conducted during said communication event and the second co-operating element comprises a second media object selected in the game conducted during said communication event.

11. The method according to claim 1, wherein the first co-operating element comprises a first portion of user inputted text and the second co-operating element comprises a second portion of user inputted text.

12. The method according to claim 1, wherein the action comprises display of at least one media object on a display of each of the plurality of user devices.

13. The method according to claim 1, wherein the action comprises outputting an audio signal using speakers of each of the plurality of user devices.

14. The method according to claim 1, wherein said messages are exchanged in accordance with a text-based messaging protocol, wherein each co-operating element corresponds to a portion of text.

15. The method according to claim 14, wherein the messages transmitted to each of the plurality of user devices each comprise a portion of text which when read at each of the plurality of user devices, causes delivery of the action using output means at the plurality of user devices.

16. The method according to claim 1, wherein the communication events is one of a voice call, video call, or instant messaging communication session.

17. A computer program product, the computer program product being embodied on a computer-readable medium and configured so as when executed on one or more processors to perform the method of claim 1.

18. A network entity comprising:
at least one memory storing information on actions which are to be triggered in response to combinations of co-operating elements;
a message builder component configured to analyse messages exchanged over a communication network during a communication event between a plurality of user devices to determine if said messages comprise a co-operating element; and
an action controller component configured, in response to determining that said message builder has identified a first co-operating element in a first message transmitted from one of said user devices, and a second co-operating element in a second message transmitted from one of said user devices, to query said memory to identify an action associated with the combination of the first and at least the second co-operating element;
wherein the message builder component is configured to transmit a message to each of the plurality of user devices to cause delivery of the action using output means at the plurality of user devices.

19. The network entity according to claim 18, wherein the at least one memory further stores information identifying the co-operating elements and the message builder component is configured to determine if a message exchanged during said communication event comprise a co-operating element by querying said memory.

20. A user terminal comprising:
an output;
at least one memory storing information on actions which are to be triggered in response to combinations of co-operating elements;
a network interface configured to transmit and receive messages between the user terminal and one or more further user terminals over a communication network during a communication between the plurality of user terminals; and
one or more processors configured to run a communication client application, the communication client application comprising:
a message builder component configured to analyse messages exchanged over the communication network during the communication event to determine if said messages comprise a co-operating element; and
an action controller component configured, in response to determining that said message builder has identified a first co-operating element in a first message transmitted from one of said user terminals, and a second co-operating element in a second message transmitted from one of said user terminals, to query said memory to identify an action associated with the combination of the first and at least the second co-operating element;
wherein the message builder component is configured to transmit a message to the one or more further user terminals to cause delivery of the action using the output at the one or more further user terminals, and is further configured to control said output to deliver the action.
